(19) United States
(12) Patent Application Publication
(10) Pub. No.: US 2026/0351578 A1
(43) Pub. Date: Nov. 5, 2026

(54) GRANULAR COMPOSITION CONTAINING GRAPHENE AND SULPHUR AND METHOD FOR PRODUCING IT

(71) Applicant: DIRECTA PLUS S.P.A., Lomazzo (CO) (IT)

(72) Inventors: Laura Giorgia Rizzi, Saronno (IT); Giulio Giuseppe Cesareo, Como (IT)

(21) Appl. No.: 18/997,201

(22) PCT Filed: Aug. 23, 2023
(86) PCT No.: PCT/EP2023/073119

§ 371 Date: Jan. 21, 2025

(30) Foreign Application Priority Data
Aug. 25, 2022 (IT) 102022000017613

(51) Int. Cl. H01M 4/38; B01F 27/112; B01F 27/19; B01F 35/90; B01F 35/92; B01F 101/59; H01M 4/04; H01M 4/62

(52) U.S. Cl. CPC H01M 4/38; B01F 27/112; B01F 27/19; B01F 35/92; H01M 4/04; H01M 4/621; H01M 4/622; H01M 4/625; B01F 2035/98; B01F 2035/99; B01F 2101/59; B01F 2215/0472; B01F 2215/0477; B01F 2215/0481

(57) ABSTRACT

Granular composition comprising sulphur, graphene nano-platelets and optionally a binder, and use of this composition to prepare a battery cathode.

The present invention relates to a granular composition containing graphene, sulphur and optionally a binder, and a method for producing this granular composition. The invention also relates to a dispersion of the granular composition in a liquid medium and the use of this dispersion for producing battery cathodes.

### CONTEXT OF THE INVENTION

The development of high energy density rechargeable batteries is currently of great commercial interest. There are many systems, such as lithium ion batteries, which can equip portable electronic systems, Ni—MH batteries, which can equip hybrid vehicles, or other technologies. Lithium-sulphur or Li—S batteries are considered promising alternatives to lithium ion batteries. Interest for this type of battery derives from the high energy density potential of sulphur. Moreover, sulphur has the advantage of being abundant, inexpensive and non-toxic, which allows large-scale development of Li—S batteries to be envisioned.

The mechanism for draining and charging an Li—S battery is based on the oxidation-reduction of sulphur at the cathode (S+2e⁻⇄S²⁻) and oxidation-reduction of lithium at the anode (Li⇄H Li⁺+e⁻).

To cause the reactions to take place rapidly on the electrodes, the cathode and the anode must be good electron conductors. However, as sulphur is an electrical insulator, it must be made conductive so as to be able to obtain high performance cathodes.

When a lithium-sulphur cell is drained, the sulphur in the cathode is reduced. As sulphur is not conductive, reduction is limited to the surface of the sulphur particles in contact with the electrolyte.

There have been various attempts to improve the electrical contact between sulphur particles and the electrolyte; in fact, it is known that sulphur or another material containing sulphur can be mixed with an electrically conductive material, such as carbon black, to improve its electrical conductivity.

However, in this way the specific energy of the lithium-sulphur cell is reduced as the total weight of the cell increases.

Moreover, attempts have been made to grind sulphur and the electrically conductive material together to form a mixture of fine particulate to improve the contact area between the electrically conductive particles.

However, an excessively fine particle size can be damaging for the porosity of the whole electrode.

### SUMMARY OF THE INVENTION

The object of the present invention is therefore to provide a granular composition comprising sulphur for producing battery cathodes that improve the performance of the cathode and hence of the batteries in which the cathode is used.

This granular composition has a substantially regular and controlled morphology, which can be dispersed in water or in an organic solvent without the need to adapt in advance to the specific type of dispersion, i.e., which is suitable to be used as is in water-based and solvent-based dispersions.

Another object of the present invention is to provide a method for the preparation of a granular composition comprising sulphur, which is simple, efficient and “without grinding”, i.e., which does not require one or more grinding steps in a mill, thereby drastically reducing processing times.

A further object of the invention is to provide a dispersion of a granular composition comprising a particulate material and one or more additives, in water o in an organic solvent, in order to be able to make battery cathodes.

One more object of the invention is to provide an improved battery cathode.

Therefore, an aspect of the present invention relates to a granular composition comprising:
a) from 50 to 95% by weight of sulphur;
b) from 5 to 50% by weight of graphene nano-platelets;
wherein at least 90% of said graphene nano-platelets has a lateral dimension (x, y) from 50 to 20000 nm and a thickness (z) from 1 to 50 nm and a C/O ratio≥35:1.

Preferably, the composition further comprises from 0.5 to 35% by weight of a binder.

In a further embodiment, the composition according to the invention further comprises from 0.5 to 35% by weight of a particulate material selected from pigments and fillers.

A further aspect of the present invention is to provide a method for the preparation of a granular composition comprising:
a) from 50 al 95% by weight of a particulate material selected from pigments and fillers;
b) from 5 to 50% by weight of graphene nano-platelets having a lateral dimension (x, y) from 50 to 20000 nm, a thickness (z) from 1 to 50 nm and a C/O ratio≥35:1;
c) optionally from 0.5 to 35% by weight of a binder;
   wherein said sulphur, said graphene nano-platelets and optionally said binder are mixed in a turbomixer apparatus provided with at least one impeller with blades rotating at a peripheral speed from 4 to 50 m/s; said method is carried out at a temperature from 20 to 150 °C.

According to another aspect, the invention relates to a dispersion of the granular composition defined above in a liquid selected from water and organic solvent.

Yet another aspect of the invention relates to the use of the granular composition or of the dispersion as described above, to make a battery cathode.

According to another aspect, the invention relates to a battery cathode containing the composition described above.

### DESCRIPTION OF THE INVENTION

In its most general aspect, the present invention relates to a composition in granular form that comprises graphene, sulphur, optionally one or more binders and optionally one or more pigments and/or fillers to provide battery cathodes with improved performance.

According to the present invention, the sulphur is preferably sulphur in elemental form.

According to the present invention, the binder is a wetting and dispersing agent that lowers the interfacial tension between the particulate material and the graphene nano-platelets, and the interfacial tension between the granular composition and a liquid, water or organic solvent, in which the granular composition is dispersed.

The granular composition of the invention comprises granules having a particle size from 10 and 4000 μm, measured with a Digital Electromagnetic Sieve Shaker Filtra® Vibration mod. FTL0200.

In the present description, the term “particle size” is meant as a value that indicates the average size of the particles, i.e., the volumetric size of the particles in the form of clusters, defined herein as “granules”.

The size of the particles based on volume is equal to the diameter of the ideal sphere internally comprising a given particle. In particular, when using sieve analysis, the diameter of the ideal sphere corresponds to the sieve mesh size. The size of the particles based on volume is measured with a Digital Electromagnetic Sieve Shaker Filtra® Vibration mod. FTL0200.

According to an aspect of the invention, the granular composition comprises granules with a size from 100 to 3000 μm, measured with a Digital Electromagnetic Sieve Shaker Filtra® Vibration mod. FTL0200.

According to an aspect of the invention, the granular composition comprises granules with a size from 500 to 3000 μm, measured with a Digital Electromagnetic Sieve Shaker Filtra® Vibration mod. FTL0200.

According to an aspect of the invention, the granular composition is essentially without solid particulate material of nanometric size, in particular it is without solid particulate material having a size of less than 1 μm, which would generate dust and create environmental problems, where the term “without” means that the solid particulate material having a size of less than 1 μm is absent or is present in amounts not exceeding 5% by weight.

According to an aspect of the invention, the granular composition comprises:
a) from 50 al 95% by weight of sulphur;
b) from 5 to 50% by weight of graphene nano-platelets;
wherein at least 90% of said graphene nano-platelets has a lateral dimension (x, y) from 50 and 20000 nm and a thickness (z) from 1 and 50 nm and a C/O ratio≥35:1.

Preferably, the granular composition comprises:
a) from 86 to 92% by weight of sulphur;
b) from 8 to 14% by weight of graphene nano-platelets.

The composition according to the present invention further comprises from 0.5 to 35% by weight of a binder.

Preferably the composition comprises from 1.5 to 6% of binder.

According to an aspect of the invention, at least 90% of said graphene nano-platelets has a lateral dimension (x, y) from 80 to 15000 nm.

According to an aspect of the invention, at least 90% of said graphene nano-platelets has a thickness (z) from 3 to 20 nm.

According to an aspect of the invention, at least 90% of the graphene nano-platelets has a C/O ratio≥45:1.

According to an aspect of the invention, at least 90% of the graphene nano-platelets has a lateral dimension (x, y) from 100 to 10000 nm.

According to an aspect of the invention, at least 90% of the graphene nano-platelets has a thickness (z) from 5 and 15 nm.

According to an aspect of the invention, at least 90% of the graphene nano-platelets has a C/O ratio≥50:1.

In the present description, the size of the graphene nano-platelets is defined with reference to a system of Cartesian axes x, y, z, it being understood that the particles are substantially flat platelets but can also have an irregular shape. In any case, the lateral dimension and the thickness provided with reference to the directions x, y and z must be understood as maximum dimensions in each of the aforesaid directions.

The structural characterization of the graphene can be carried out with the test method ISO/TS 21356-1, 202103.

The structural characterization of the graphene incorporated in the composition of the invention can be carried out by separating the graphene from the particulate material, i.e., the pigment or the filler, and from the binder, as well as from any other component of the composition, with methods known to the person skilled in the art.

Graphene is a material consisting of a single atomic layer of hybrid carbon atoms in sp2 form. Therefore, they are arranged in closely-spaced hexagonal honeycomb structures, highly crystalline and regular.

In the scientific and patent literature, different methods are disclosed for the preparation of graphene, such as chemical vapor deposition, epitaxial growth, chemical exfoliation and chemical reduction of the oxidized form of graphene (GO).

The Applicant Directa Plus S.p.A. is the holder of patents and patent applications relating to methods for the production of structures comprising layers of graphene, such as EP 2 038 209 B1, EP 3 157 864 B1 and 3 157 865B1 . The last two patents mentioned describe methods for the production of pristine graphene dispersions, from which it is possible to obtain graphene nano-platelets with the sizes required for the implementation of the present invention.

A pristine graphene, i.e., with a C/O ratio≥35 and with the size characteristics defined above, is produced, and marketed by Directa Plus S.p.A. with the brand G+®.

The C/O ratio in the graphene used in the composition according to the invention is determined by elemental analysis carried out with elemental analyzer (CHNS O), which provides the percentage by weight of the various elements.

When more accurate determination is required, the C/O ratio is determined using the transmission electron microscope (TEM) combined with energy dispersive X-ray spectroscopy (TEM-EDX) This is a combination of two effective techniques, as with SEM it is possible to see the microscopic surface structures of the sample with high precision and more closely compared to a conventional optical microscope. A scanning electron microscope can have a resolution of less than 1 nm, much higher than an optical microscope. Therefore, a more accurate and higher quality image of the surface topography of the sample is obtained. Alternatively, SEM can be replaced by TEM, i.e., transmission electron microscopy.

When wishing to determine the elemental composition of the sample, an EDX detector is connected to the SEM or TEM apparatus. The EDX detector identifies the elements present in the sample and determines their concentration and distribution. This allows an accurate determination of C and O.

According to the implementations described in the abovementioned patent documents, the process for the production of graphene is carried out continuously, continuously feeding the graphite flakes to the high temperature expansion step, continuously discharging the expanded graphite thus obtained in an aqueous medium and continuously subjecting the expanded graphite dispersed in the aqueous medium to an exfoliation and size reduction treatment carried out with the methods of ultrasonication and/or high pressure homogenization.

As described in these patent documents, the final dispersion of the graphene nano-platelets obtained can be concentrated or dried, depending on the final form required for the graphene. The purpose of drying the dispersion is to obtain a dry powder that is easily re-dispersible in various matrices, both solvents and polymers, where liquid is not desirable or manageable at process level, or where water cannot be used due to chemical incompatibility.

A significant advantage of the production processes described in the aforementioned patent documents is the possibility of operating without the use of surfactants. In fact, the graphene nano-platelets thus obtained can be pristine, both for the high C/O ratio and for the absence of foreign substances that could contaminate them, such as surfactants. In fact, it has been found that in the absence of surfactants it is possible to obtain graphene having substantially higher electrical conductivity than that of graphene obtained with processes that use surfactants. This improves the performance of the graphene in a plurality of applications.

The graphene nano-platelets with the lateral dimension, thickness (z) and C/O ratio defined above have a high thermal conductivity.

The binder of the granular composition of the invention is a wetting and dispersing agent selected from the group consisting of:
polyurethane oligomers and polyurethane polymers having a content of modified polyurethane of 100%;
non-ionic surfactants, including fatty acids ethoxylates, alcohol ethoxylates and ethoxylated sorbitan esters, preferably not containing alkylphenol ethoxylates (APEO) and volatile organic compounds (VOC), including sorbitan monooleate;
anionic surfactants, preferably not containing alkylphenol ethoxylates (APEO) and volatile organic compounds (VOC); including sodium polynaphthylmethane sulphonate, polymers with oxirane, sodium polyphosphates, sodium salts of polyacrylic acid;
phosphoric acid esters and their salts, including 6 EO and 9 EO tridecyl phosphoric esters;
aldehyde and ketone resins;
epoxidized soybean oils;
polyethers modified with ester groups of phosphoric acid and their salts;
polyesters modified with fatty acids;
polymers and copolymers with pigment-affinic groups, including modified polyethers with groups of high pigment affinity;
2,5-Furandione, telomer with 1,1′-(1,1-dimethyl-3-methylene-1,3-propanediyl)bis(benzene) and ethenylbenzene, 3-(dimethylamino)propyl imide, imide with polyethylene glycol 2-aminopropyl Me ether, 2-[(C10-16-alkyloxy)methyl]oxirane-quaternized, benzoates (salts); sodium polycarboxylate;
mixture of 5-chloro-2-methyl-2H-isothiazol-3-one with 2-methyl-2H-isothiazol-3-one (CAS N° 55965-84-9).

With regard to non-ionic surfactants, APEO-and VOC-free, these preferably have a pH of 5-7 and a viscosity up to 100 s, the latter measured according to the standard DIN EN ISO 2431, flow cup 6 mm, 23 °C.

With regard to aldehyde and ketone resins, products distributed by BASF, such as Laropal®, with mean molecular weight from 800 to 2000 Da and melting point from 70 °to 130 °C, can, for example, be mentioned.

With regard to the copolymers with pigment-affinic groups, examples are the products marketed with the brand Byk 2055 by BYK-Chemie.

With regard to the non-ionic wetting and emulsifying agents without alkylphenols, the products marketed with the brand Nuosperse FN265 by Elementis can be mentioned.

The classes of binders described above have high affinity with sulphur and the graphene that forms the granular composition of the invention. They guarantee stabilization of the sulphur particles, and of the graphene nano-platelets that form the composition, thereby also stabilizing the granules of the composition. Moreover, the binder stabilizes dispersion of the granules in the composition.

According to the present invention, the composition can also comprise from 0.5 to 35% by weight of a particulate material selected from pigments and fillers.

According to the present description, the term “particulate material” means a pigment or a filler in the form of solid particles or powder.

According to the present invention, pigments and fillers are substances or compounds that absorb part or all the light spectrum and reflect the complementary part, forming visible colors. According to the invention, a particulate material as defined above is combined with graphene nano-platelets and optionally with a binder, and optionally with other additives, and made available as composition in granular form, suitable to be further processed to obtain the desired battery cathode.

The particulate material is therefore a material that, if combined with graphene and made available in granular form, has advantageous properties for the composition.

According to another aspect of the present invention, the solid particulate material is a filler. Preferably, the filler is selected from the group consisting of calcium carbonate, kaolin, mica, talc, silica, preferably pyrogenic silica, barium sulphate and any combination of these elements. According to an aspect of the invention, the filler consists of calcium carbonate.

The composition according to the invention can also comprise carbon black, nanotubes, graphite.

The granular composition according to the invention can be prepared by mixing the components in a turbomixer apparatus.

The turbomixer apparatus is a high shear granulator comprising a cylindrical receptacle with at least one inlet and at least one outlet, optionally a heating and/or cooling sleeve to take and/or maintain the temperature inside the receptacle to/at a predetermined temperature. A rotating shaft with at least one impeller provided with blades is mounted inside the receptacle in the chamber. The receptacle is closed by a top cover. A schematic and partial representation of this apparatus is shown in FIGS. 1A, 1B and 1C, which do not show the top cover.

The particulate material, the graphene nano-platelets and the binder are introduced into the turbomixer apparatus, as shown in FIG. 1A. The impeller is rotated so that the blades reach a peripheral speed from 4 to 50 m/s. Mixing takes place at a temperature from 20 to 150 °C.

The apparatus moves the mixture of graphene, binder and pigment and/or filler from the static phase and pushes it to form a vortex similar to that of a tornado which, being closed inside a cylindrical chamber, starts to swirl in a spiral from the bottom towards the top of the chamber, as shown in FIG. 1B. The mixture then collapses toward the center of the chamber through gravity and, due to the barrier provided by the top cover, as shown in FIG. 1C, the mixture descends towards the lower part of the receptacle, where it is once again pushed upward and outward to form the ascending spiral. This effect creates the vortex that ensures mixing and clustering of the particles, thereby allowing the formation of granules without dust and with good flow.

The presence of impellers that cut through the flow of the vortex and oppose advance of the particles ensures the dispersion of any micro-clusters, thereby guaranteeing optimal dispersion of the graphene and its homogeneous distribution inside the granule. The mechanical energy from mixing/clustering is transformed into thermal energy through the revolution and shear action carried out by the vortex.

Preferably, the rotating shaft comprises from 1 to 7 impellers, more preferably 4 impellers, mounted in series on said rotating shaft.

Preferably, the turbomixer apparatus comprises a heating and/or cooling sleeve to control the temperature of the chamber in which the components are mixed.

Preferably, the temperature is from 30 °C and 150 °C, more preferably from 60-120 °C.

Preferably, the process is carried out for a total time from 5 and 60 minutes.

According to an aspect of the present invention, the binder is introduced into the turbomixer gradually, i.e., continuously in time.

According to an aspect of the present invention, preparation of the composition of the invention takes place discontinuously, for example in batch mode rather than in continuous mode.

According to an aspect of the present invention, the preparation method of the composition of the invention is carried out without the use of any solvent, i.e., it is a substantially dry process. The term “dry” means that the amount of liquid in the process does not exceed 5% by weight of the whole composition.

In particular, the term “solvent” means a substance, or a mixture of substances, that is able to dissolve or disperse other substances and that is liquid at room temperature, i.e., from 20-40 °C, for example a non-polar solvent, an aprotic polar solvent, a protic polar solvent or any mixture thereof, including diluents that do not have a solubilizing effect on any of the components of the mixture.

According to an aspect, the invention relates to a dispersion of the granular composition defined above in a liquid selected from water and an organic solvent, where the term “solvent” has the same meaning as above.

The composition defined above is suitable to be used as is to produce water-based and solvent-based dispersions. These dispersions, which can also be defined “pastes” if the amount of liquid is relatively small, are further processed to produce battery cathodes.

The examples set down below illustrate some embodiments of the invention and are provided by way of non-limiting example.

### EXAMPLES

The apparatus used to prepare the granular compositions of the invention was a turbomixer with a receptacle with a volume of 20 liters equipped with 4 impellers.

The graphene consists of nano-platelets manufactured by Directa Plus S.p.A., with the particle sizes indicated in each example below.

### Example 1

COMPOSITION: S: 85% GNPs: 10% binder: 5%
5300 g of powdered elemental sulphur was mixed and ground with 600 g of Pure G+ (Directa Plus) pure graphene nano-platelet powder. Said graphene comprises graphene nano-platelets in which at least 90% has a lateral dimension below 9905 nm and thickness (z) D90 of 8 nm, C/O ratio of the graphene 40:1.

The wetting agent DisperByk 2013 (Byk) 300 g was added to the two components.

The dry milling apparatus was a 201 discontinuous apparatus equipped with 4 rotors. Given the explosive nature of the sulphur powder, the chamber was maintained in an inert atmosphere (nitrogen) for the whole of the preparation time.

Process parameters: 20 minutes at the peripheral speed of 23 m/s; the temperature reached 75 °C. Particle size of the granules obtained: <1500 μm.

### Example 2

### COMPOSITION: S: 85 GNPS: 10% BINDER: 5%

5300 g of powdered elemental sulphur was mixed and ground with 600 g of Pure G+ (Directa Plus) pure graphene nano-platelet powder. Said graphene comprises graphene nano-platelets in which at least 90% has a lateral dimension below 9905 nm and a thickness (z) D90 of 8 nm, C/O ratio of the graphene 50:1.

The wetting agent DisperByk 2055 (Byk) 300 g was added to the two components.

The dry milling apparatus was a 201 discontinuous apparatus equipped with 4 rotors. Given the explosive nature of the sulphur powder, the chamber was maintained in an inert atmosphere (nitrogen) for the whole of the preparation time.

Process parameters: 20 minutes at the peripheral speed of 23 m/s; the temperature reached 75 °C. Particle size of the granules obtained: <1500 μm.

### Example 3

5300 g of powdered elemental sulphur was mixed and ground with 600 g of Pure G+ (Directa Plus) pure graphene nano-platelet powder. Said graphene comprises graphene nano-platelets in which at least 90% has a lateral dimension below 9905 nm and a thickness (z) D90 of 8 nm, C/O ratio of the graphene 75:1.

The wetting agent Tween 80 (Croda) 300 g was added to the two components.

The dry milling apparatus was a 201 discontinuous apparatus equipped with 4 rotors. Given the explosive nature of the sulphur powder, the chamber was maintained in an inert atmosphere (nitrogen) for the whole of the preparation time.

Process parameters: 20 minutes at the peripheral speed of 23 m/s; the temperature reached 75 °C. Particle size of the granules obtained: <1500 μm.

### Example 4

### Composition: S: 86.3% GNPs: 10.7% Binder: 3%

5178 g of powdered elemental sulphur was mixed and ground with 642 g of Pure G+ (Directa Plus) pure graphene nano-platelet powder. Said graphene comprises graphene nano-platelets in which at least 90% has a lateral dimension below 9905 nm and a thickness (z) D90 of 8 nm, C/O ratio of the graphene 85:1.

The wetting agent Atmer 110 (Croda) 180 g was added to the two components.

The dry milling apparatus was a 201 discontinuous apparatus equipped with 4 rotors. Given the explosive nature of the sulphur powder, the chamber was maintained in an inert atmosphere (nitrogen) for the whole of the preparation time.

### Example 5

COMPOSITION: S: 86.3% GNPs: 10.7% binder: 3%

5178 g of powdered elemental sulphur was mixed and ground with 642 g of Pure G+ (Directa Plus) pure graphene nano-platelet powder. Said graphene comprises graphene nano-platelets in which at least 90% has a lateral dimension below 9905 nm and a thickness (z) D90 of 8 nm, C/O ratio of the graphene 100:1.

The wetting agent DisperByk 2055 (Byk) 180 g was added to the two components.

The dry milling apparatus was a 201 discontinuous apparatus equipped with 4 rotors. Given the explosive nature of the sulphur powder, the chamber was maintained in an inert atmosphere (nitrogen) for the whole of the preparation time.

### Example 6

### COMPOSITION: S: 89% GNPs: 11%

5340 g of powdered elemental sulphur was mixed and ground with 660 g of Pure G+ (Directa Plus) pure graphene nano-platelet powder. Said graphene comprises graphene nano-platelets in which at least 90% has a lateral dimension below 9905 nm and a thickness (z) D90 of 8 nm, C/O ratio of the graphene 90:1.

The dry milling apparatus was a 201 discontinuous apparatus equipped with 4 rotors. Given the explosive nature of the sulphur powder, the chamber was maintained in an inert atmosphere (nitrogen) for the whole of the preparation time.

### Example 7

The graphene preparation of Example 1 was used to make an aqueous dispersion containing the additive of the example at 58.4% by weight. 510.73 g of deionized water was placed in a container and the additive was added during stirring. 716.91 g of additive was added. The dispersion was produced with a DISPERMAT CN 40 apparatus equipped with a VMA 60 Cowles head set to rotate at 4000 rpm. The additive was added in 3 batches of around 238 g each; after each addition of additive the disperser was left rotating for 4 minutes at 4000 rpm. The dispersion is stable and tends to film easily. After being left to rest for 48 hours there is an abundant presence of precipitate on the bottom, which is re-dispersed simply by stirring the receptacle manually.

### Example 8

The graphene preparation of Example 3 was used to make an aqueous dispersion containing the additive of the example at 58.4% by weight. 462.82 g of deionized water was placed in a container and the additive was added during stirring. 592.4 g of additive was added. The dispersion was produced with a DISPERMAT CN 40 apparatus equipped with a VMA 60 Cowles head set to rotate at 4000 rpm. The additive was added in 5 batches of around 120 g each; after each addition of additive the disperser was left rotating for 4 minutes at 4000 rpm. After the fifth addition the disperser was left rotating for 5 minutes at 5500 rpm.

Compared to Example 4, after each addition an abundant foam formed on the surface of the receptacle, which was left to deposit before the subsequent addition.

The dispersion is stable and tends to film easily. After being left to rest for 48 hours there is an abundant presence of precipitate on the bottom, which is re-dispersed simply by stirring the receptacle manually.

### Example 9

The preparations of Examples 1, 3 and 6 were tested to evaluate their electrical conductivity performance. The same test was carried out on sulphur powder as is. 3 grams of each of the three powders was compacted on a paper medium, until obtaining a layer of around 4 mm of compact powder.

The surface resistivity of the four samples was measured with the instrument Loresta-GX, MCP T700 with ESP probe (MCP-TP08P).

The three preparations with graphene gave a surface resistivity of 10E+01 Ohm/square, while the sulphur was an insulator (>E+08).

### Example 10

The graphene preparation of Example 4 and the sulphur as is (i.e., not mixed with graphene nano-platelets) were subjected to quantification of the electrical resistivity.

In detail, the preparations with graphene were analyzed using the instrument Loresta-GX (Nittoseiko Analytech Co.), which allow analysis of samples with surface resistivity in the range 10⁻⁴-10⁷ Ω. Instead, the sulphur as is, being a non-conductive material, was analyzed with the instrument Hiresta-UX (Nittoseiko Analytech Co.), useful for samples with a surface resistivity in the range 10³-10¹⁴ ω.

The PD-600 powder measuring system probe was used with both instruments.

7 g of preparation with graphene was compacted at different pressures: 4-8-12-16 and 20 kN. The compressed material was then subjected to surface resistivity analysis.

The same preparation as the sample was carried out on the sulphur as is, but for this material 2 g of powder was sufficient to obtain the samples to be analyzed.

For both samples, the tests were conducted in duplicate.

The preparation with graphene was very conductive for all the pressures tested. On average, the sample showed a surface resistivity of 5.06E+01.

The sulphur as is instead proved to be a non-conductive material, with an average value for all pressures of 2.65E+14.

1-10. (canceled)

11. A granular composition comprising:
a) from 50 to 95% by weight of sulphur; and
b) from 5 to 50% by weight of graphene nano-platelets;
wherein at least 90% of the graphene nano-platelets have a lateral dimension from 50 to 20000 nm and a thickness from 1 to 50 nm and a carbon-to-oxygen (C/O) ratio≥35:1.

12. The granular composition of claim 11, further comprising from 0.5 to 35% by weight of a binder.

13. The granular composition of claim 11, wherein the binder is a wetting and dispersing agent selected from the group consisting of:
polyurethane oligomers and polyurethane polymers having a content of modified polyurethane of 100%;
non-ionic surfactants, including fatty acids ethoxylates, alcohol ethoxylates and ethoxylated sorbitan esters;
anionic surfactants;
phosphoric acid esters and their salts, including 6 EO and 9 EO tridecyl phosphoric esters;
aldehyde and ketone resins;
epoxidized soybean oils;
polyethers modified with ester groups of phosphoric acid and their salts;
polyesters modified with fatty acids;
polymers and copolymers with pigment-affinic groups, including modified polyethers with groups of high pigment affinity;
2,5-Furandione, telomer with 1,1′-(1,1-dimethyl-3-methylene-1,3-propanediyl)bis(benzene) and ethenylbenzene, 3-(dimethylamino)propyl imide, imide with polyethylene glycol 2-aminopropyl Me ether, 2-[(C10-16-alkyloxy)methyl]oxirane-quaternized, benzoates (salts);
sodium polycarboxylate;
mixture of 5-chloro-2-methyl-2H-isothiazol-3-one with 2-methyl-2H-isothiazol-3-one (CAS N° 55965-84-9).

14. The granular composition of claim 13, wherein the non-ionic surfactants do not contain alkylphenol ethoxylates (APEO) and volatile organic compounds (VOC).

15. The granular composition of claim 13, wherein the anionic surfactants do not contain alkylphenol ethoxylates (APEO) and volatile organic compounds (VOC).

16. The granular composition of claim 11, comprising granules having a particle size from 10 to 4000 μm.

17. A battery cathode comprising the granular composition of claim 11.

18. A method for preparation of a granular composition, wherein the granular composition comprises from 50 to 95% by weight of sulphur and from 5 to 50% by weight of graphene nano-platelets having a lateral dimension from 50 to 20000 nm, a thickness from 1 to 50 nm, and a carbon-to-oxygen (C/O) ratio≥35:1, the method comprising:
mixing the sulphur and the graphene nano-platelets in a turbomixer apparatus provided with at least one impeller with blades rotating at a peripheral speed from 4 to 50 m/s,
wherein the method is carried out at a temperature from 20 to 150 °C.

19. The method of claim 17, wherein the granular composition further comprises from 0.5 to 35% by weight of a binder, and wherein the method comprises mixing the sulphur, the graphene nano-platelets and the binder in the turbomixer apparatus.

20. The method of claim 17, wherein the turbomixer apparatus comprises a rotating shaft equipped with from 1 to 7 impellers mounted in series on the rotating shaft, and a heating and/or cooling jacket to control the temperature.

21. The method of claim 17, wherein the method is carried out for a total time comprised between 5 and 60 minutes.

22. A method for manufacturing a battery cathode, comprising:
preparation of a granular composition, wherein the granular composition comprises from 50 to 95% by weight of sulphur and from 5 to 50% by weight of graphene nano-platelets having a lateral dimension from 50 to 20000 nm, a thickness from 1 to 50 nm, and a carbon-to-oxygen (C/O) ratio≥35:1, wherein preparation of the granular composition comprises mixing the sulphur and the graphene nano-platelets in a turbomixer apparatus provided with at least one impeller with blades rotating at a peripheral speed from 4 to 50 m/s, at a temperature from 20 to 150 °C; and
dispersion of the granular composition in a liquid selected from water and an organic solvent.

23. The method of claim 22, wherein the prepared granular composition further comprises from 0.5 to 35% by weight of a binder, and wherein the preparation of the granular composition comprises mixing the sulphur, the graphene nano-platelets and the binder in the turbomixer apparatus.

24. The method of claim 22, wherein the turbomixer apparatus comprises a rotating shaft equipped with from 1 to 7 impellers mounted in series on the rotating shaft, and a heating and/or cooling jacket to control the temperature.

25. The method of claim 22, wherein the preparation of the granular composition is carried out for a total time comprised between 5 and 60 minutes.
